(19) United States
(12) Patent Application Publication
(10) Pub. No.: US 2007/0229671 A1
(43) Pub. Date: Oct. 4, 2007

(54) Remote control system including remote controller with image pickup function

(75) Inventors: Masahiro Takeshita, Daito-shi (JP); Yasuo Masaki, Daito-shi (JP); Kouichi Ishimoto, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/728,823

(22) Filed: Mar. 27, 2007

(30) Foreign Application Priority Data
Mar. 28, 2006 (JP) 2006-088745

(51) Int. Cl. H04N 5/232

(52) U.S. Cl. 348/211.2

(57) ABSTRACT

A remote control system is made up by a remote controller for remotely operating equipment such as an air conditioner and a television, and a cradle connected to a commercial power supply and having a charging function for the remote controller. The remote controller is equipped with a camera and a communication unit capable of communicating through a network. The cradle is equipped with a light unit such as an LED.

### BACKGROUND OF THE INVENTION

1. Field of the Invention

The present invention relates to a remote control system, and particularly to a remote control system including a remote controller with a camera and a cradle of the remote controller.

2. Description of the Background Art

Conventionally, various techniques utilizing a digital camera as a monitoring camera have been disclosed.

For example, in Japanese Patent Laying-Open No. 2003-338950, there is disclosed a technique in which a cradle detachably supporting a digital camera is equipped with a function of moving the digital camera in a plurality of directions.

Moreover, in Japanese Patent Laying-Open No. 2004-080309, there is disclosed a technique in which a cradle is configured so as to be powered from an automobile, so that a digital camera connected to the cradle can perform image pick-up operation for a long time even in a car.

Furthermore, in Japanese Patent Laying-Open No. 2004-140589, there is disclosed a technique in which by pressing a specific switch provided in a cradle, a digital camera in a state of being connected to the cradle can perform image pick-up operation without light-emitting operation to operate as a monitoring camera.

That is, conventionally, by connecting the digital camera to the cradle, and making the digital camera perform the image pick-up operation while continuously powering, the digital camera has been adapted to assume the function as the monitoring camera.

While in the above-described Japanese Patent Laying-Open No. 2003-338950, Japanese Patent Laying-Open No. 2004-080309, and Japanese Patent Laying-Open No. 2004-140589, the techniques in which the digital camera is powered by being connected to the cradle are disclosed, techniques in which a cradle is equipped with a plurality of functions including a function of supplying power to a digital camera are disclosed in Japanese Patent Laying-Open No. 2003-204462 and Japanese Patent Laying-Open No. 2005-221925.

In a case where the digital camera is adapted to assume the function as the monitoring camera as shown in Japanese Patent Laying-Open No. 2003-338950, Japanese Patent Laying-Open No. 2004-080309, and Japanese Patent Laying-Open No. 2004-140589, there arises a problem that a user cannot carry the digital camera when the digital camera is made to monitor a room in his or her absent home or when the digital camera is made to monitor a user's car left behind while he or she goes sightseeing on visit to a sightseeing spot.

### SUMMARY OF THE INVENTION

The present invention is devised in light of the above-described situations, and an object of the present invention is to make equipment that a user does not need to carry assume a function as a monitoring camera.

According to the present invention, a remote control system includes a remote controller for remotely operating an equipment, and a cradle connected to a commercial power supply and having a charging function for the remote controller, wherein the remote controller includes an image pick-up unit and a communication unit capable of connecting the remote controller to a network; and the cradle includes a light unit for increasing illuminance of a field of view of the image pick-up unit.

Moreover, in a remote control system according to the present invention, preferably, the remote controller includes: an image pick-up unit; a communication unit capable of connecting the remote controller to a network; a control unit for controlling operation by the image pick-up unit; a connector to be connected to the cradle; an input unit to which information on an image pickup aspect in a state of the connector being connected to the cradle is inputted; a receiver for receiving a signal for requesting transmission of an image picked up by the image pick-up unit; a transmitter for transmitting a control signal to the equipment; and a storage for storing a predetermined condition and a type of the control signal to be transmitted to the equipment in association with each other, wherein the control unit controls image pickup operation by the image pick-up unit based on the information inputted to the input unit when the connector is connected to the cradle, determines whether or not a field of view of the image pick-up unit is appropriately light for image pickup based on contrast of the image picked up by the image pick-up unit, when the connector is connected to the cradle, transmits a signal for lighting the light unit to the cradle if the control unit determines that the field of view of the image pick-up unit is not appropriately light for image pickup, and makes the communication unit transmit the image through the network if the control unit determines to transmit the image through the network based on the image picked up by the image pick-up unit or if the receiver receives the signal for requesting the transmission of the image; the receiver further receives the signal for requesting the lighting of the light unit; the control unit transmits the signal for lighting the light unit to the cradle, provided that the receiver receives the signal for requesting the lighting of the light unit, and determines whether or not the image picked up by the image pick-up unit satisfies the predetermined condition, and if the control unit determines that the predetermined condition is satisfied, makes the transmitter transmit to the equipment the type of the control signal stored in the storage in association with the predetermined condition; the transmitter transmits the control signal to the equipment based on control by the control unit or based on the signal received by the communication unit through the network; and the cradle includes a first light unit for emitting visible light and a second light unit for emitting near infrared light.

According to the present invention, the remote controller including the image pick-up unit can transmit the image picked up by the image pick-up unit to a server or the like through the network, and further, when illuminance of the field of view of the image pick-up unit is short, lighting the light unit included in the cradle enables the remote controller to function as a monitoring camera.

The remote controller is for remotely operating an equipment installed in a room or the like. That is, it is ordinarily unthinkable to carry it outside of the room.

Thus, according to the present invention, equipment that the user does not need to carry can assume the function as the monitoring camera.

Moreover, according to the present invention, the light unit having a relatively large power consumption is provided in the fixable cradle instead of the remote controller to be carried in the room or the like, so that a battery life of the remote controller itself can be made longer.

Moreover, according to the present invention, since the image pick-up unit of the remote controller executes the image pickup operation provided that the remote controller is connected to the cradle, it is possible to avoid a situation where the image pickup operation is not executed due to the user forgetting the operation and the like, thereby enabling the remote controller to surely function as the monitoring camera.

Moreover, according to the present invention, since the image pickup operation by the image pick-up unit in making the remote controller function as the monitoring camera can be based on the information inputted to the input unit, the image pickup operation can be executed in an aspect desired by the user.

Still further, according to the present invention, if the control unit determines that the field of view of the image pick-up unit is dark, that is, automatically, the light unit of the cradle can be lighted.

Still further, according to the present invention, since the remote controller can transmit the image picked up by the image pick-up unit to the server based on the information received through the network, the image at timing desired by the user can be supplied through the network.

Still further, according to the present invention, since the remote controller can transmit the signal for controlling the equipment to the equipment based on the image picked up by the image pick-up unit. Thereby, when abnormality occurs in the room subjected to monitoring by the remote controller, it is possible to make the remote controller address the abnormality before the user arrives at the room.

According to the present invention, since the cradle can include the light unit for emitting visible light and the light unit for emitting near infrared light, the type of the image picked up by the image pick-up unit can be diversified.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view schematically showing one embodiment of a remote control system of the present invention;

FIG. 2 is a view showing an outer appearance of a remote controller of FIG. 1;

FIG. 3 is a view schematically showing a state where the remote controller of FIG. 1 is connected to a cradle;

FIG. 4 is a control block diagram of the remote controller of FIG. 1;

FIG. 5 is a control block diagram of the cradle of FIG. 1;

FIG. 6 is a flowchart of processing executed by a control circuit of FIG. 4 in a case where the remote controller is utilized as a monitoring camera;

FIG. 7 is a view showing a first modification of the cradle of FIG. 3;

FIG. 8 is a diagram showing the first modification in the control block diagram of the cradle of FIG. 5;

FIG. 9 is a view showing a second modification of the cradle of FIG. 3; and

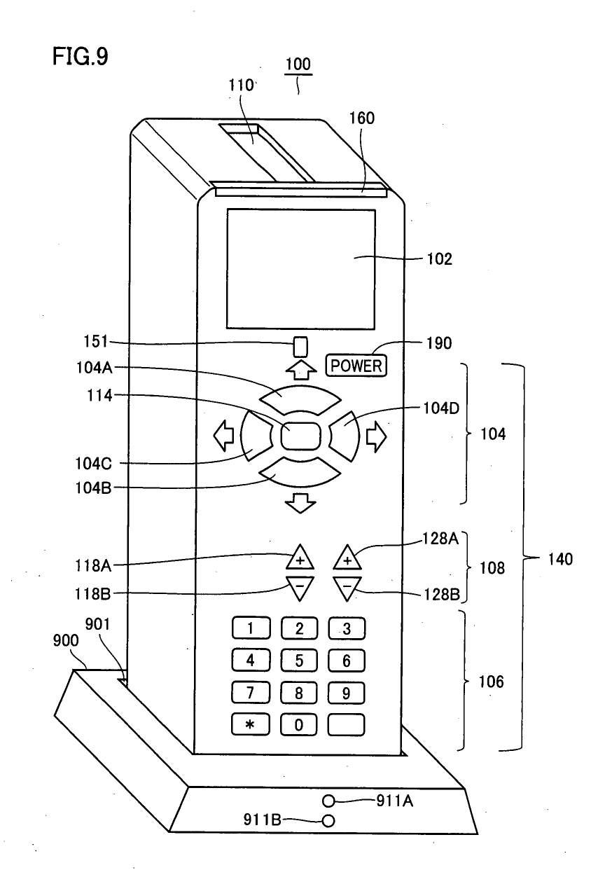

FIG. 10 is a diagram showing the second modification in the control block diagram of the cradle of FIG. 5.

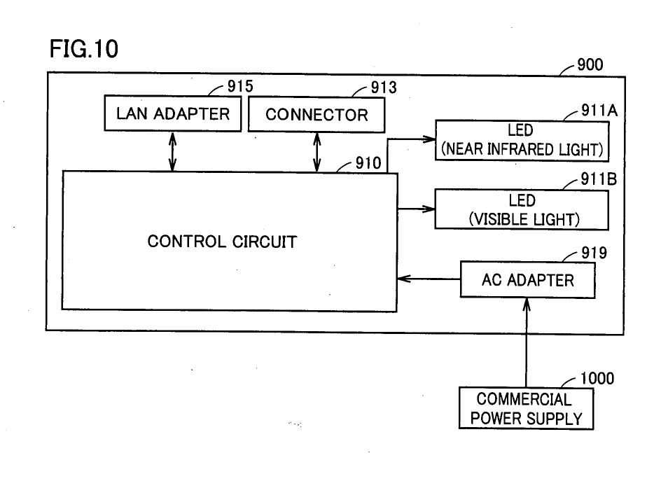

### DESCRIPTION OF THE PREFERRED EMBODIMENTS

Hereinafter, referring to the drawings, an embodiment of the present invention is described. In the following description, identical reference numerals designate identical parts. Names and functions thereof are also identical. Accordingly, their detailed descriptions are not repeated.

First, a use aspect of a remote controller 100 composing a remote control system according to the present invention is described.

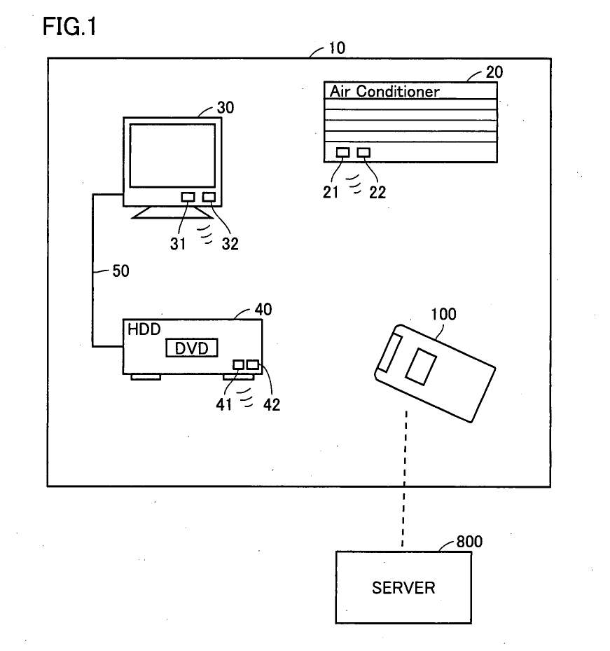

Referring to FIG. 1, in a room 10, an air conditioner 20, a television 30, and an HDD recorder 40 are arranged. Air conditioner 20 includes a light emitter 21 for emitting a light signal including identification information on the air conditioner itself, and a light receiver 22 for receiving a light control signal emitted by remote controller 100. Television 30 includes a light emitter 31 for emitting a light signal including identification information on the television itself, and a light receiver 32 for receiving a light control signal emitted by remote controller 100. Television 30 and HDD recorder 40 are connected to each other by a cable 50. HDD recorder 40 includes a light emitter 41 for emitting a light signal including identification information on the HDD recorder itself, and a light receiver 42 for receiving a light control signal emitted by remote controller 100. Remote controller 100 can be connected to a server 800 through a network, for example.

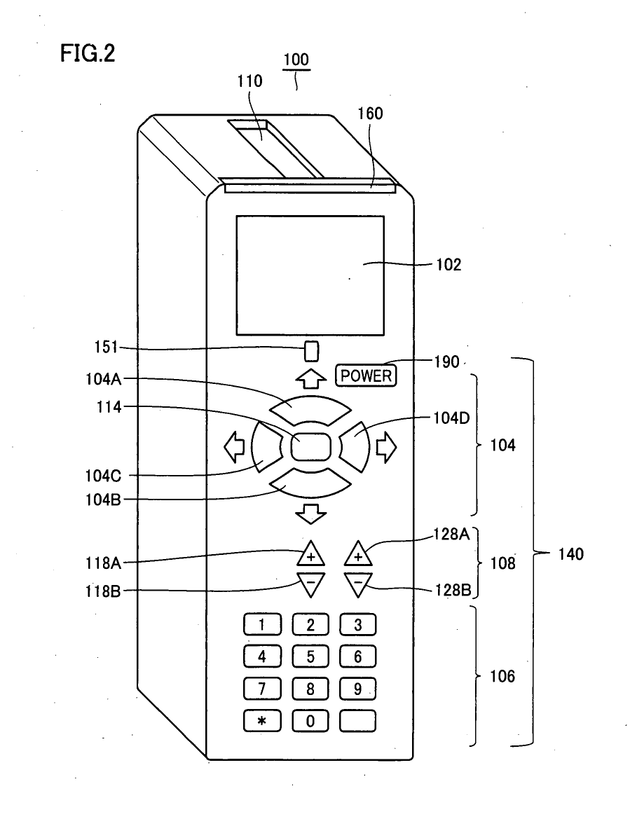

Referring to FIG. 2, a configuration of remote controller 100 according to the present embodiment is described. FIG. 2 is a view showing an outer appearance of remote controller 100.

Remote controller 100 includes a slit 110 for transmitting the light signal, a light emitter 160 for emitting a light control signal to controlled equipment, a display 102, a camera 151, an operation unit 140 for receiving input of an instruction outside and outputting a signal according to the input, and a power supply switch 190 for accepting input of an instruction of power-on.

Operation unit 140 is realized by a button, a dial and a touch panel, for example. Operation unit 140 includes cursor buttons 104A, 104B, 104C, 104D for defining up and down, and left and right directions of a cursor displayed on display 102, a determination button 114 for receiving input of an instruction for deciding data inputted by a user of remote controller 100, up/down buttons 108 for increasing or decreasing a value of the output control signal, and numeric buttons 106. Up/down buttons 108 include a first up button 118A, a first down button 118B, a second up button 128A, and a second down button 128B.

Power supply switch 190 accepts the input of the instruction for switching power-on and off of the particular equipment in a case where remote controller 100 functions as a remote controller for controlling the equipment.

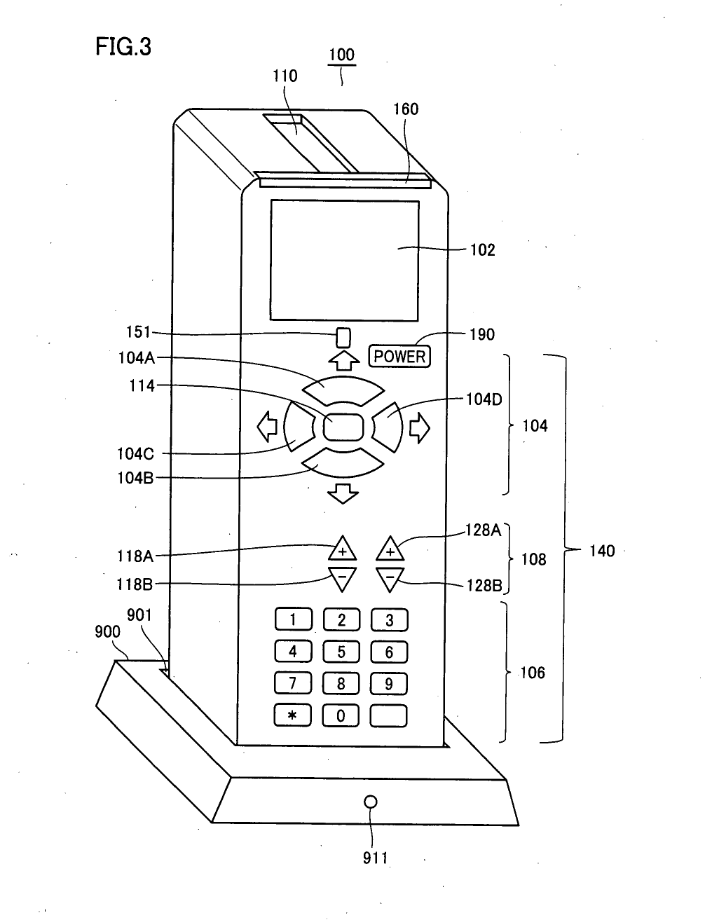

The remote control system according to the present invention includes a cradle for charging remote controller 100 in addition to remote controller 100. In FIG. 3, a state where remote controller 100 is connected to a cradle 900 is schematically shown.

Referring to FIG. 3, in cradle 900, a recessed portion 901 is formed on a top surface thereof, in which a lower portion of remote controller 100 is placed. On a front surface of the cradle 900, an LED (Light Emitting Diode) 911 is provided. Camera 151 in remote controller 100 is configured so as to be capable of picking up image even in a state of being connected to the cradle 900, as shown in FIG. 3. LED 911, by being lighted in such a state, functions as an light unit for increasing illuminance of a field of view of camera 151.

Side surfaces of cradle 900 are tapered, so that LED 911 is arranged to emit light slightly upward, thereby enabling the light emitted by LED 911 to effectively light up the field of view of camera 151.

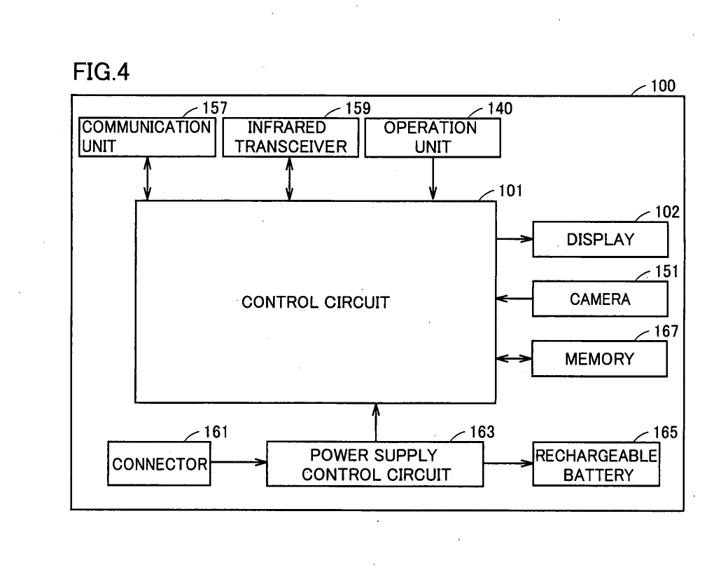

FIG. 4 is a control block diagram of remote controller 100.

Referring to FIG. 4, remote controller 100 includes, in addition to display 102, camera 151, and operation unit 140, a connector 161, a power supply control circuit 163, a rechargeable battery 165, a control circuit 101 for controlling operations of respective components of remote controller 100, a memory 167, a communication unit 157, and an infrared transceiver 159.

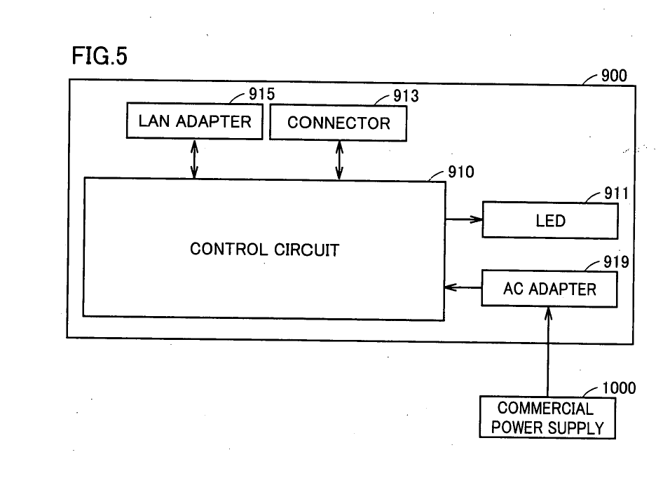

FIG. 5 is a control block diagram of cradle 900.

Referring to FIG. 5, cradle 900 is powered by a commercial power supply 1000 through an AC adapter 919, and includes a control unit 910, a LAN (local area network) adapter 915, and a connector 913.

In a state shown in FIG. 3, connector 161 of remote controller 100 and connector 913 of cradle 900 are connected to each other. Thereby, in remote controller 100, rechargeable battery 165 is powered by cradle 900 through power supply control circuit 163 to be charged.

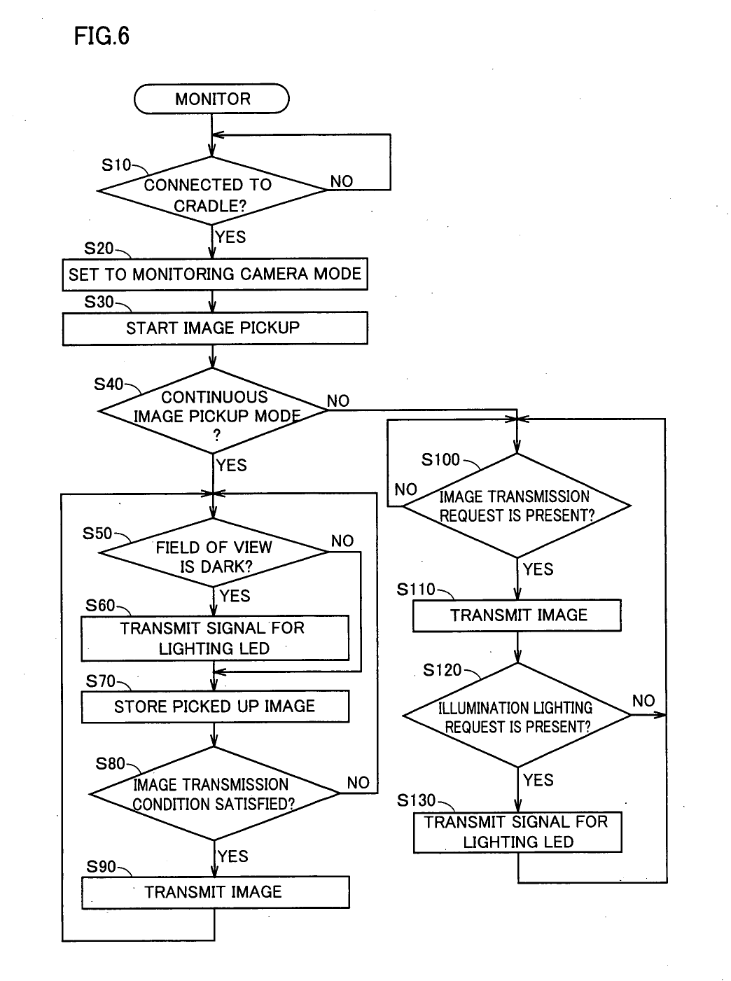

FIG. 6 is a flowchart of processing executed by control circuit 101 when remote controller 100 is utilized as a monitoring camera.

In step S10, control circuit 101 first determines whether or not remote controller 100 is connected to cradle 900, and if it is determined that remote controller 100 is connected, the processing is advanced to step S20.

In step S10, control circuit 101 determines whether or not connector 161 is connected to connector 913.

In step S20, control circuit 101 sets to a monitoring camera mode. More particularly, in remote controller 100, setting contents on an image pickup aspect of camera 151 are preliminarily stored in memory 167 as setting contents for the monitoring camera mode.

Control circuit 101 makes camera 151 start image pickup in step S30.

Next, in step S40, control circuit 101 determines whether or not the setting has been made to perform continuous image pickup in use as the monitoring camera by checking the information stored in memory 167. If the setting has been made, the processing is advanced to step S50, while if it is determined that the setting has not been made, the processing is advanced to step S100.

In step S50, control circuit 101 determines whether or not the field of view of camera 151 is dark. More particularly, in step S50, control circuit 101 determines whether or not contrast is less than a predetermined value by analyzing an image picked up by camera 151. If it is determined that the field of view of camera 151 is dark, the processing is advanced to step S60. If it is determined that it is not dark, that is, if it is determined that it has sufficient illuminance (the field of view of camera 151 is appropriately light for image pickup), control circuit 101 advances the processing to step S70.

In step S60, control circuit 101 transmits a signal for lighting LED 911 to cradle 900 through connector 161. In response to this, control circuit 910 of cradle 900 lights LED 911.

Next, in step S70, control circuit 101 stores the image picked up by camera 151 in memory 167, and advances the processing to step S80.

In step S80, control circuit 101 determines whether or not a predetermined condition (hereinafter, referred to as an image transmission condition) is satisfied on the image stored in step S70 executed immediately before. If it is determined that such a condition is satisfied, the image is transmitted to the predetermined equipment such as server 800 or the like in step S90, and the processing is returned to step S50, thereby enabling the user in a remote place to obtain information on occurrence of abnormality in the room and the like from the image. On the other hand, if it is determined that the image transmission condition is not satisfied, the processing is returned to step S50 as it is.

Examples of the image transmission condition may include such that the stored image includes an image of a prowler intruding the room. The determination as to whether or not such a condition is satisfied can be performed by utilizing a technique of image pattern identification or the like.

On the other hand, in step S100, control circuit 101 determines whether or not a signal for requesting the transmission of the image picked up by camera 151 has been received from the external device such as server 800. If it is determined that such a signal has been received, the processing is advanced to step S110.

In step S110, control circuit 101 transmits the image picked up by camera 151 at this point to a predetermined address such as server 800 or the like, and advances the processing to step S120.

If the user, viewing the picked up image through server 800 or the like, determines that the field of view of camera 151 is dark, he or she can transmit a signal for requesting the lighting of the illumination.

In step S120, control circuit 101 determines whether or not such a signal has been received, and if the reception is determined, advances the processing to step S130, in which, as in step S60, the signal for lighting LED 911 is transmitted to cradle 900, and returns the processing to step S100. On the other hand, if it is determined that such a signal has not been received, control circuit 101 returns the processing to step S100 without executing the processing in step S130.

In the above-described present embodiment, remote controller 100 is charged by being connected to cradle 900. Remote controller 100 is equipped with camera 151 and the communication function, thereby capable of functioning as the monitoring camera by utilizing the camera 151.

By viewing the image transmitted from remote controller 100 by the processing in step S110, the user can transmit the signal for lighting LED 911 to remote controller 100.

Additionally, the user can transmit a signal for requesting the transmission of a control signal for making remote controller 100 turn on television 30 or turn on an illuminating appliance in room 10.

Thereby, when the intrusion of a prowler is recognized from the transmitted image, the user can intimidate the prowler by making remote controller 100 light the illumination in the room or the like while he or she is in a remote place.

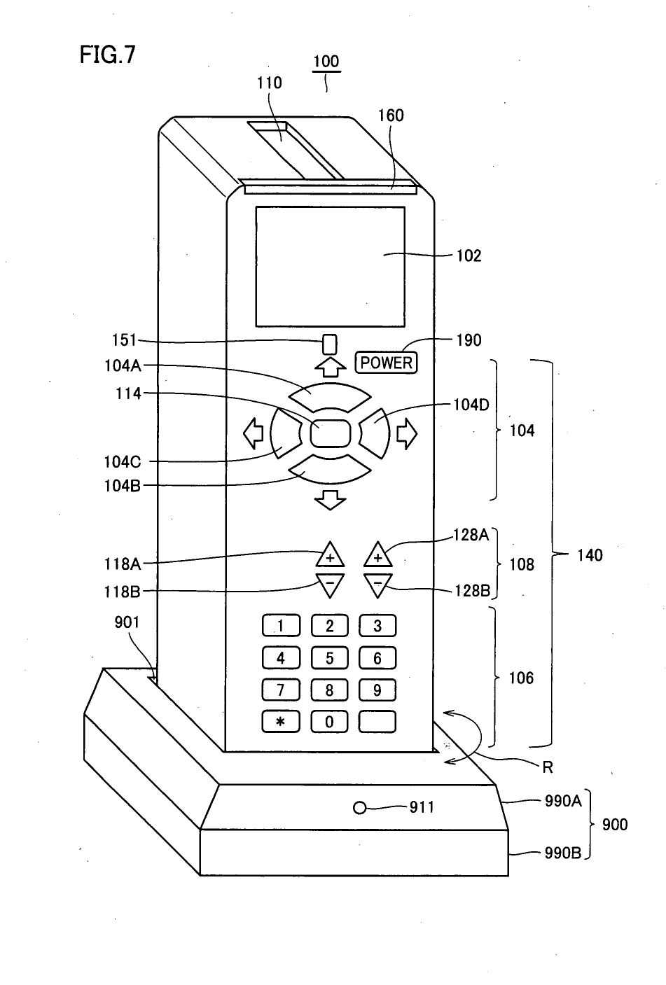

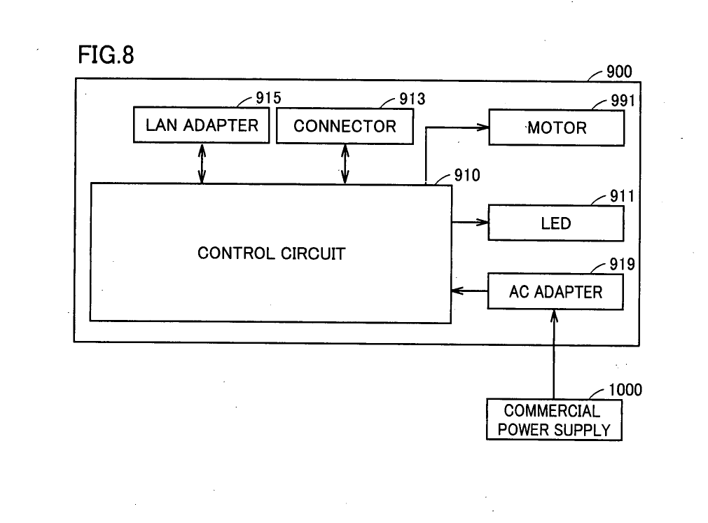

Moreover, in order to change the field of view of camera 151, the cradle may be rotatably configured. That is, as shown in FIG. 7, cradle 900 includes a rack 990A for setting remote controller 100 thereon, and a stand 990B for supporting rack 990A from beneath rotatably in an arrow R direction. In this case, cradle 900 is equipped with a motor 991 imbedded in stand 990B for rotating rack 990A, as shown in FIG. 8. Motor 991 is controlled by control circuit 910 to thereby appropriately rotate. The rotation of motor 991 allows rack 990A to rotate in the arrow R direction with respect to stand 990B.

Furthermore, cradle 900 may be configured to selectively emit visible light and near infrared light. That is, cradle 900 thereby enables LED 911 to image pickup visibly or invisibly at first glance.

Still further, while according to the present embodiment, cradle 900 is provided with the control unit independently, LED 911 in cradle 900 may be configured such that operation is controlled directly by control circuit 101 in remote controller 100.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A remote control system comprising:
a remote controller for remotely operating an equipment and
a cradle connected to a commercial power supply and having a charging function for said remote controller, wherein
said remote controller includes an image pick-up unit and a communication unit capable of connecting said remote controller to a network; and
said cradle includes a light unit for increasing illuminance of a field of view of said image pick-up unit.

2. The remote control system according to claim 1, wherein
said remote controller includes:
a control unit for controlling operation by said image pick-up unit; and
a connector to be connected to said cradle, and
said control unit makes said image pick-up unit execute image picking up operation, provided that said connector is connected to said cradle.

3. The remote control system according to claim 2, wherein
said remote controller further includes an input unit to which information on a image pickup aspect in a state of said connector being connected to said cradle is inputted; and
said control unit controls the image pickup operation by said image pick-up unit based on the information inputted to said input unit when said connector is connected to said cradle.

4. The remote control system according to claim 2, wherein
said control unit determines whether or not a field of view of said image pick-up unit is appropriately light for image pickup when said connector is connected to said cradle; and
said cradle lights said light unit if said control unit determines that the field of view of said image pick-up unit is not appropriately light for image pickup.

5. The remote control system according to claim 4, wherein
said control unit transmits a signal for lighting said light unit to said cradle if said control unit determines that the field of view of said image pick-up unit is not appropriately light for image pickup.

6. The remote control system according to claim 4, wherein
said control unit determines whether or not the field of view of said image pick-up unit is appropriately light for image pickup based on contrast of an image picked up by said image pick-up unit.

7. The remote control system according to claim 1, wherein
said remote controller includes a control unit for controlling operation by said image pick-up unit and
said control unit determines whether or not to transmit an image through said network based on the image picked up by said image pick-up unit, and only if said control unit determines to transmit, makes said communication unit transmit the image through said network.

8. The remote control system according to claim 1, wherein
said remote controller further includes:
a control unit for controlling operation by said image pick-up unit; and
a receiver for receiving a signal for requesting transmission of an image picked up by said image pick-up unit, and
said control unit makes said communication unit transmit the image through said network, provided that said receiver receives the signal for requesting the transmission of said image.

9. The remote control system according to claim 8, wherein
said receiver further receives a signal for requesting lighting of said light unit; and
said control unit transmits a signal for lighting said light unit to said cradle, provided that said receiver receives the signal for requesting the lighting of said light unit.

10. The remote control system according to claim 1, wherein
said control unit determines whether or not an image picked up by said image pick-up unit satisfies a predetermined condition, and
said remote controller further includes:
a transmitter for transmitting a control signal to said equipment;
a storage for storing said predetermined condition and a type of the control signal to be transmitted to said equipment in association with each other, and
said control unit makes said transmitter transmit to said equipment the type of the control signal stored in said storage in association with said predetermined condition.

11. The remote control system according to claim 1, wherein
said remote controller further includes a transmitter for transmitting a control signal to said equipment; and
said transmitter transmits the control signal to said equipment based on a signal received by said communication unit through said network.

12. The remote control system according to claim 1, wherein
said light unit includes a first light unit for emitting visible light and a second light unit for emitting near infrared light.

13. A remote control system comprising:
a remote controller for remotely operating an equipment and
a cradle connected to a commercial power supply and having a charging function for said remote controller, wherein
said remote controller including:
an image pick-up unit;
a communication unit capable of connecting said remote controller to a network;
a control unit for controlling operation by said image pick-up unit;
a connector to be connected to said cradle;
an input unit to which information on a image pickup aspect in a state of said connector being connected to said cradle is inputted;
a receiver for receiving a signal for requesting transmission of an image picked up by said image pick-up unit;
a transmitter for transmitting a control signal to said equipment; and
a storage for storing a predetermined condition and a type of the control signal to be transmitted to said equipment in association with each other, wherein
said control unit controls image pickup operation by said image pick-up unit based on the information inputted to said input unit when said connector is connected to said cradle,
determines whether or not a field of view of said image pick-up unit is appropriately light for image pickup based on contrast of the image picked up by said image pick-up unit, when said connector is connected to said cradle,
transmits a signal for lighting said light unit to said cradle if the control unit determines that the field of view of said image pick-up unit is not appropriately light for image pickup, and
makes said communication unit transmit the image through said network if the control unit determines to transmit the image through said network based on the image picked up by said image pick-up unit or if said receiver receives the signal for requesting the transmission of said image;
said receiver further receives the signal for requesting the lighting of said light unit;
said control unit transmits the signal for lighting said light unit to said cradle, provided that said receiver receives the signal for requesting the lighting of said light unit, and
determines whether or not the image picked up by said image pick-up unit satisfies the predetermined condition, and if the control unit determines that said predetermined condition is satisfied, makes said transmitter transmit to the equipment the type of the control signal stored in said storage in association with said predetermined condition;
said transmitter transmits the control signal to said equipment based on control by said control unit or based on the signal received by said communication unit through said network;
said cradle includes a first light unit and a second light unit for increasing illuminance of a field of view of said image pick-up unit;
said first light unit emits visible light; and
said second light unit emits near infrared light.
